(19) United States
(12) Patent Application Publication
(10) Pub. No.: US 2020/0342425 A1
(43) Pub. Date: Oct. 29, 2020

(54) ACCOUNT BALANCE SHARING SYSTEM

(71) Applicant: LYDIANS ELEKTRONIK PARA VE ODEME HIZMETLERI ANONIM SIRKETI, Istanbul (TR)

(72) Inventor: Fatih TOSMUR, Adana (TR)

(73) Assignee: LYDIANS ELEKTRONIK PARA VE ODEME HIZMETLERI ANONIM SIRKETI, Istanbul (TR)

(21) Appl. No.: 16/926,728

(22) Filed: Jul. 12, 2020

Related U.S. Application Data
(63) Continuation-in-part of application No. PCT/TR2019/050025, filed on Jan. 10, 2019.

(30) Foreign Application Priority Data
Jan. 12, 2018 (TR) 2018/00435
Jan. 9, 2020 (TR) 2020/00322

(51) Int. Cl. G06Q 20/06; G06Q 20/36; G06Q 20/34

(52) U.S. Cl. CPC G06Q 20/065; G06Q 20/352; G06Q 20/3674

(57) ABSTRACT

A credit card sharing system that enables an end user to make a payment on behalf of users added to an application through the user adding module just by using a mobile or similar device without carrying a physical credit card. Users define a temporary limit on at least one credit card which is defined into the system and which is owned by the user; and a temporary limit to be spent at member shops by the member users, for which this temporary limit is defined. An alternative account sharing method includes a person sharing an amount of money in his or her account instead of sending money to other users. Thus, the account owner keeps all rights and control over the money while maintaining their usage parameters. Instead of a money transfer, the account sharing method provides an alternative financial feature.

### CROSS REFERENCE TO THE RELATED APPLICATIONS

This application is a continuation-in-part application based on the International Application No. PCT/TR2019/050025, filed Jan. 10, 2019 and which claims priority to patent application TR 2018/00435, filed on Jan. 12, 2018, and also claims priority to Turkish patent application TR 2020/00322, filed Jan. 9, 2020, the entire contents of which are incorporated herein by reference.

### TECHNICAL FIELD

The invention subject matter of the application is related to at least one credit card sharing system that enables the end user to pay on behalf of users added to the application through the user adding module just by using a mobile or similar device without carrying a physical credit card; that enables these users to define a temporary limit on at least one credit card which is defined into the system and which is owned by the user; and that enables the defined temporary limit to be spent at member shops by the member users of which this temporary limit is defined.

In another embodiment of the invention, an account sharing method has been developed. In this account sharing method, an account is shared between individuals and/or entities instead of a credit card. Also, in the account sharing method a person can share a given or certain amount of money in his or her account instead of sending money to other users. Thus, the account owner keeps all rights and control over the money while maintaining their usage parameters. Instead of a money transfer, the account sharing method provides an alternative financial feature.

### BACKGROUND

In the prior art, there are systems that enable to make payments without requiring use of physical cards by registering the credit cards in applications used in mobile devices. However, the basic logic behind these systems is that they facilitate the credit card user to make payment without using the physical credit card.

Besides, during payments in said systems, the device running the application in which the credit card is registered must be used with the payment device at the business where the transaction takes place. In order to perform the payment procedure, the two devices must communicate with each other by using NFC (Near Field Communication) protocol. The payment can only be made by being approved after this stage.

In these systems, it is not possible for a credit card owner to authorize other users to use the credit card limit via the same application or similarly it is not possible for other users to use other people's credit cards for their own payments.

In the prior art of account sharing, people share money directly with other users via a simple money transfer. The money is transferred from one account to another account as a financial record. When the money transfer is approved, all the usage and control rights on the money of the sender is lost by the transfer.

Another prior art model is a supplementary card model. In this model, supplementary cards are created by a main credit card holder and the usage limits are defined for the cards. The supplementary cards use the defined limits of the main credit cards. In the supplementary card model, the main credit cardholder is also the owner of the supplementary card; there is basically no sharing. In the supplementary card model, all supplementary cards has dependency to main card. If the main card is cancelled, all supplementary cards are inactivated. In presented method, all cards are independent.

At the same time, supplementary card functions are in the form of sharing the credit card limit in existing applications. Basically, the limit of the main credit card is shared, not the money or an account. For this reason, the supplementary card is operated on a completely different basis than the model offered.

In the presented invention, the account is used as the main sharing source. The account owner keeps the main control over the account and money after a successful sharing. The presented method supports managing features and controls such as defining usage of limits and usage restrictions with monitoring transactions made by the participants.

### SUMMARY

In the present invention, for spending in member businesses via the credit card, a user having a credit card can define a temporary expense limit to at least one user among the users who use the same application and who have been added to the application through the member addition module or in response to a request from one of the users who was added to the application via member addition module, the person can directly make a payment to a member business on behalf of that user.

With the presented model or method of “account sharing”, a person can share a given or certain amount of money is his or her account instead of sending money to other users. Thus, the account owner keeps all rights and control over the money with maintaining their usage parameters. Instead of a money transfer, the presented method of account sharing provides an alternative financial feature.

In the development of the credit card sharing system of the invention, it is aimed that;
A user having a credit card can define a temporary expense limit from at least one of his credit cards to another user who does or does not own a credit card but uses the same application and who has been added to the application via a member addition module,
A user having a credit card can make a payment to member businesses on behalf of another user who does or does not own a credit card but uses the same application and who has been added to the application via a member addition module,
A user having a credit card can request a temporary limit to spend in member businesses from another user who owns a credit card, “who” uses the same application and who has been added to the application via member addition module,
A user having a credit card can request from another user who owns a credit card, who uses the same application and who has been added to the application via member addition module, to make a payment to a member business on behalf of him,
These transactions can be performed mutually between all users who use the application and who have added each other to the application via a member addition module,
A user who does or does not own a credit card can make a payment to a member business via the system without using a physical credit card with at least one card with a temporary limit defined for him by another user added to the application via the member addition module.

In the another embodiment of the invention which is account sharing, it is aimed;
To avoid the transfer of money, sharing of a physical card or card information.
To maintain the authorizations of the sharing person on the shared money and account.
To ensure that the transactions regarding the shared account are traceable by the account owner.
To provide a flexible structure in which users can define the relationship between the account and the card and to use the same account at any time by connecting a different means of payment.
To add additional functions such as amount, duration, usage place restrictions and expenditure management features as usage parameters on the shared account.

### BRIEF DESCRIPTION OF THE DRAWINGS

The figures and descriptions related to these figures used for providing a better understanding of the model proposed are given below.

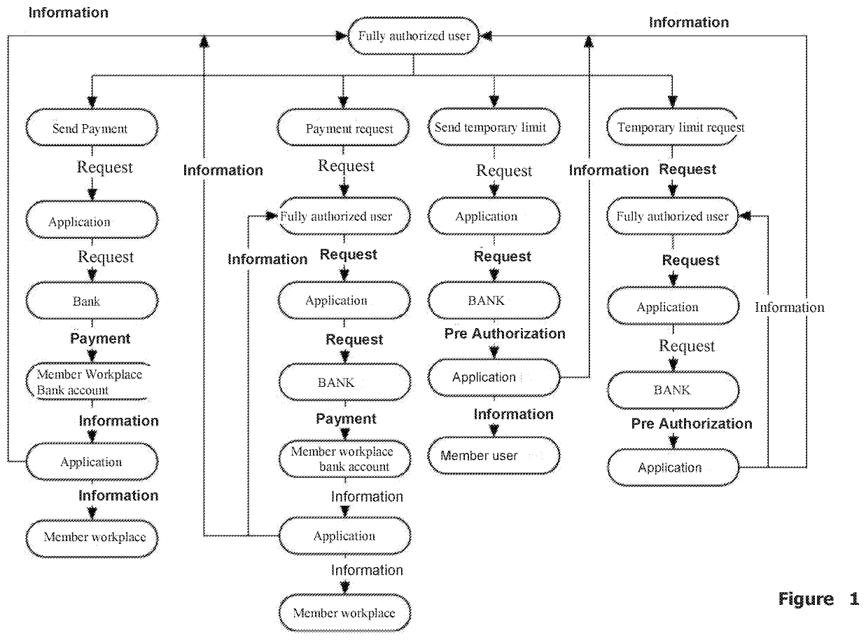

1.) FIG. 1—Flowchart of Account Sharing

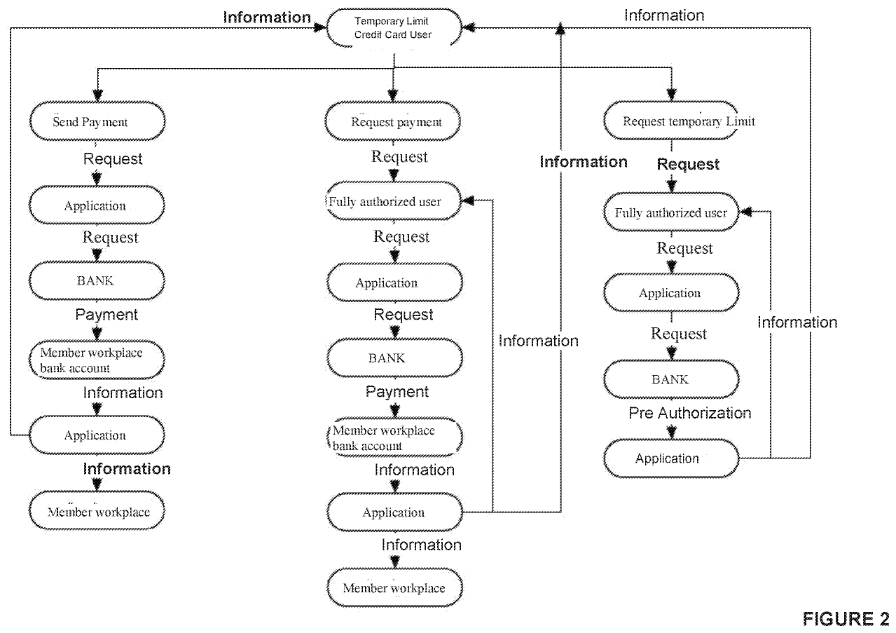

2.) FIG. 2—Spending from the Shared Account (e.g. Open Circuit Card)

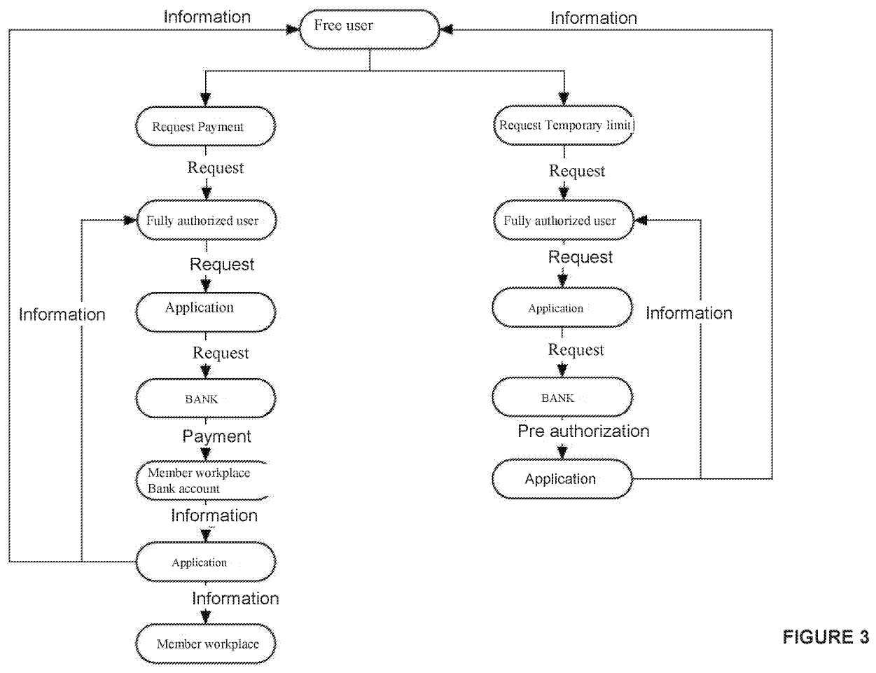

3.) FIG. 3—Account Payment Tool Architecture

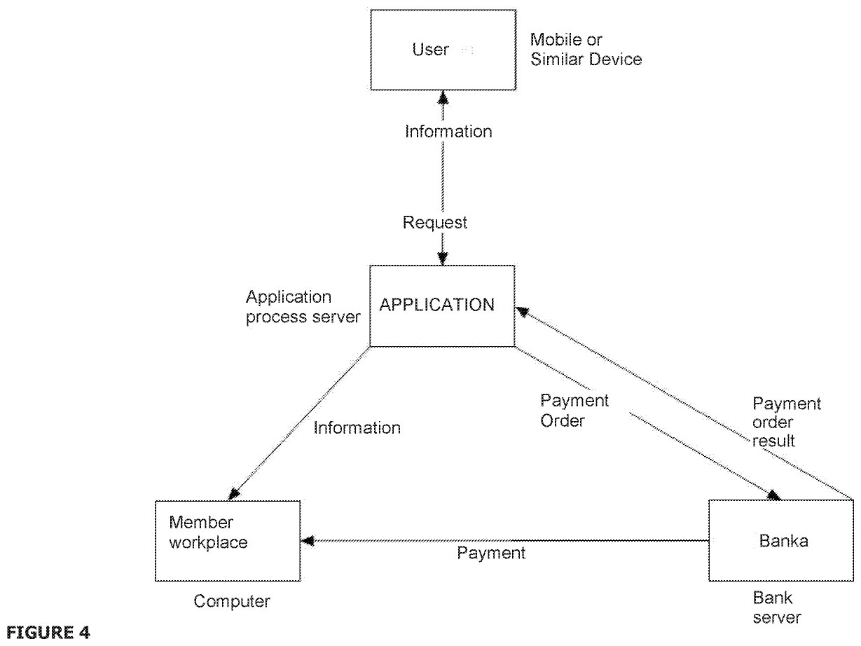

4.) FIG. 4—Suspending of Account Sharing

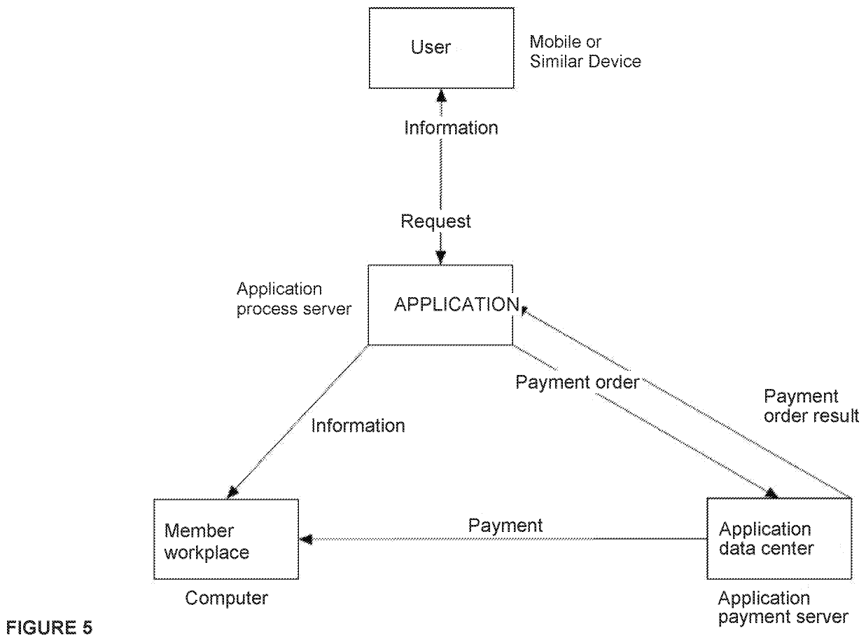

5.) FIG. 5—Adding a Person to Account Sharing

### DETAILED DESCRIPTION OF THE FIRST EMBODIMENT

In its most basic form, the credit card sharing system of the invention which is an embodiment of the invention comprises at least one server and at least one mobile application.

In order for the system to be activated, the mobile application needs to be installed onto a mobile or similar device which may belong to any user and user record needs to be created in the server. Together with this, in an embodiment of the invention at least a member workplace (merchant) and at least a bank and/or at least a credit agency must be included in the system for the usage of system functions. In another embodiment of the invention, the system functions may be operational without the need to include any kind of credit agency or bank to the system.

Following the recording of these aspects into the system, the “credit card sharing” system is operated, and the operation and usage of the system is carried out by 6 basic process modules.

### A. User Registration Module:

The user registration module primarily enables the registration of the end user who is going to be using the system, to the system.

The below mentioned process steps are carried out for a member to become a user by completing the registration module functions of the end user.
Installing a mobile application belonging to the system subject to the invention into a mobile or a similar device. The mobile application mentioned here, could be a version that is suitable for any kind of mobile processing system, but it could also have a structure that can be installed to any kind of mobile or other similar device which uses the related processing system.
Creating a member user registration in the system by using the directives provided to the user by the mobile application that has been downloaded into a mobile or other similar device.
Confirming the information entered via a verification method used by the system and completing the member user record. The verification method provided by the system that is mentioned here, can be any one of the verification methods used in the prior art such as verification by sms, verification by e-mail etc.

The member user registrations that have been entered into the system are grouped under 3 basic user types:
1. Free User: This is a user who is registered as a user into the system, but for whom a credit card has not been identified and who can use the functions of the system in a limited way, and who can only request a “temporary limit” or “payment” from other member users that have identified at least one credit card into the system and which are registered members to the system and who have been added to the application via only the member addition module.
2. Temporary Limit User: The temporary limit used, is a user to whom a “temporary limit credit card” has been identified by one or more member users, who is included into the system via the member addition module, and who can be observed to be registered into the system, having at least one credit card. This type of user has limited rights to use the system functions and he/she can only request “payment” or “temporary limit” from other member users that have at least a credit card and who are observed to be registered to the system or are added to the application via a member addition module and can transfer payment to member businesses using the “temporary limit credit card” that has been assigned for them.
3. Fully Authorized User: The fully authorized user is a user who has been registered to the system as a member user, who is a part of the system, who has added at least another user to the system and who has identified at least a credit card to the system. This type of user can use all of the system functions, can carry out payments for member workplaces (merchants) with his/her credit card, can make payments to member workplaces (merchants) on behalf of other member users who he/she has added by means of his/her own credit card via the member addition module, can transfer temporary limits to these users from his/her own credit card and may request payments to be carried out from these users to member workplaces (merchants) and/or can request a temporary limit for himself/herself.

The fully authorized user can not only transfer a temporary limit but can also carry out temporary limit transfers at certain periods of time regularly.

The user registration module “of credit card sharing” cannot be used to record member workplaces (merchants) directly to the system.

In order for a member workplace (merchant) to be registered to the system the related company must first of all make a written registration request application to the system.
After the registration request is received by the system, it shall be evaluated in terms of suitability according to certain criteria, and after it is confirmed, a member workplace (merchant) code is assigned for the related workplace (merchant) and the related workplace shall be registered to the system with a member workplace (merchant) status. The member workplace (merchant) code that is pre-defined by the system has at least 8 digits, and it may comprise the license plate code, the post code, the phone code of the city where the member workplace (merchant) is located, the identification number assigned by the system for the member workplace (merchant) and/or the branch identification code that is assigned again by the system for each branch if the member workplace (merchant) has more than one branch, and it may also comprise a specific identification code that may be created by a pre-determined algorithm that is used by the system.

### B. Member User Addition Module:

The member user addition module basically enables the addition of, other member users that the member users who would like to use the system together with, to the application that has been downloaded to a mobile or other similar device.

The completion of the member user addition module functions shall be carried out by means of the below mentioned steps.
Addition of one or more member users to the application in a mobile or similar device who has already been registered to the system via the user registration module, by the member user who has been registered to the system again via the user registration module. The addition process herein, can be carried out via the directory registration of a mobile or similar device, via social media applications, other mobile applications or manually.
Confirming the member user addition process via a verification method used by the system, by the member user that is desired to be added to the system and completing the member user addition process. The verification method used herein, by the system may be any of the verification methods that are used in the known art such as sms verification, e-mail verification etc. and it may also be a verification method that shall be carried out over the system application as the system application shall be downloaded into the devices of both member users.

### C. Credit Card Identification Module:

The credit card identification module primarily enables the addition of at least a credit card that is desired to be used by the member user who is going to use the system, into the application of a mobile or other similar device.

The completion of the credit card identification module functions are provided by means of process steps that have been mentioned below.
Defining one or more credit cards to the system which belongs only to the user by entering the credit card information into the related fields on the mobile application by the user who has been registered as a member user to the system via the user registration module.
Confirming the credit card identification process via the verification method used by the system and completing the process. The verification method used by the system here, can be any one of the verification methods used in the prior art such as verification by sms, verification by e-mail etc.

The usage of the credit card identification module is optional and it is possible for the member user to use the system without identifying a credit card.

The registered credit card information is protected by means of encoding with at least 128 bits via the PCI DSS (Payment Card Industry Data Security Standard) standard or any other version thereof by the system according to an embodiment of the invention and is stored in the system in this manner.

In another embodiment of the invention the credit card information that has been identified, is stored in the memory of a mobile or other similar device into which the mobile application is downloaded and/or in the database of a credit agency and/or bank.

### D. Temporary Limit Request and Temporary Limit Transfer Module:

The temporary limit request and the temporary limit transfer module basically enables all member user types that shall be using the system to request a temporary limit from at least one of the member users that are credit card owners who have been observed to be registered to the system and who have been added to the application via the member addition module and if this request is confirmed, the module enables the identification of a credit card that is temporary and limited for the new member for which the request is carried out by the user member.

The completion of the temporary limit request and temporary limit submission module functions, by identifying them to a temporary limit credit card is carried out by means of the process steps that have been mentioned below.
At least for one of the member users that own at least a credit card, who has been observed to be registered to the system and who has been added to the system via the member addition module by the member user to request a temporary limit.
Submission of the temporary limit request to the member for whom the request was made by the system.
Selection and confirmation of at least one of the credit cards that are registered to their own application by the member user for whom the request has been made for a temporary limit request.
Identifying the confirmed limit request by the system to the application of the member user for whom the temporary limit credit card is requested.

The temporary limit credit card which has been defined here, can be optionally cancelled by the member user for whom the temporary limit credit card has been identified for and/or by the member user who has transferred the temporary limit.

The temporary limit credit card that has not been cancelled by the person transferring the temporary limit or the member user for whom the temporary limit credit card has been identified, shall remain open to the usage of this user for a predetermined period of time, and when this pre-determined period expires, the card is cancelled by the system. This application is used for increasing temporary limits that have been identified, at certain periods of time regularly.

A lower limit identification cannot be carried out via the temporary limit that has been identified as a temporary limit credit card to any member user and this limit cannot be transferred to another member user.

In another embodiment of the invention the process of identifying the temporary limit request that has been confirmed to the application of the member user who has requested this limit as a temporary limit credit card, is carried out by receiving a pre-authorization from the credit agency and/or bank and collecting the temporary limit from the member user credit card.

In another embodiment of the invention, the identification process of the temporary limit request that has been confirmed, by the system as a temporary limit credit card to the application of the member user who has made the request, is carried out, by collecting the temporary limit that has been identified from the credit card of the member user who has performed the temporary limit transfer process, and by keeping it in the system.

### E. Payment Request Module:

The payment module basically allows all member user types who shall be using the system, to request the transfer of a payment directly to the member workplace (merchant) by at least one member user who is observed to have at least a credit card that is registered to the system, who has been added to the application via the member addition module.

In another embodiment of the invention, the payment request module is based on the principal of submitting the payment confirmation received by the system to the related credit agency or bank, and for this agency to make the payment to the member workplace (merchant), and the schematic view regarding this application has been provided in FIG. 4.

The completion of the payment request module functions according to this embodiment of the invention has been enabled by the process steps mentioned below.
The member user requests a direct payment specific to a single process that necessitates payment to a member workplace (merchant) from at least one of the member users that are observed to have at least a credit card registered to the system, who have been added to the application via the member addition module.
The system submits the member workplace (merchant) payment request to the member user and member workplace (merchant) that the payment shall be transferred to.
The member user that has received the member workplace (merchant) payment request confirms the payment by selecting at least a credit card that is observed to be registered to the system via the application.
The system submits the payment confirmation that has been received to the credit agency or bank.
The credit agency or bank that has received the payment confirmation regarding the payment to the member workplace (merchant) transfers the payment to the member workplace (merchant).
A notification is sent via the application to the member user that has carried out the payment request, the member user from which the payment was requested and the workplace (merchant) who will receive the payment once the payment to the member workplace (merchant) has been completed successfully.
A warning is sent via the application to the member user who has made the payment request, the member user from which the payment has been requested and to the member workplace (merchant) that shall be receiving the payment if the payment to the workplace (merchant) is unsuccessful.

In another embodiment of the invention, the payment request module is based on the principle that the payment confirmation is received by the system, and the system withdraws the payment from the credit card of the member user who is carrying out the payment process and transferring said payment to the member workplace (merchant), and the schematic view relating to this embodiment has been shown in FIG. 5.

The completion of the payment request module functions according to this embodiment of the invention has been enabled by the process steps mentioned below.
The member user requests a direct payment specific to a single process that necessitates payment to a member workplace (merchant) from at least one of the member users that are observed to have at least a credit card registered to the system, who have been added to the application via the member addition module.
The system submits the member workplace (merchant) payment request, to the member user from whom the payment has been requested and to the member workplace (merchant).
The member user that has received the member workplace (merchant) payment request confirms the payment by selecting at least a credit card that is observed to be registered to the system via the application.
The member confirms the payment by selecting at least a credit card that can be observed to be registered to the system via the application to enable the payment amount to be withdrawn by the system from the credit card that has been selected by the member user regarding the received payment confirmation, and the payment is transferred to the system.
The payment amount that is transferred to the system is transferred to the member workplace (merchant) to which the payment shall be made to, by the system.
A notification is sent via the application to the member user that has carried out the payment request, the member user from which the payment was requested, and to the workplace (merchant) who will receive the payment once the payment to the member workplace (merchant) has been completed successfully,
A warning is sent via the application to the member user who has made the payment request, to the member user from which the payment has been requested and to the member workplace (merchant) that shall be receiving the payment if the payment to the workplace (merchant) is unsuccessful,
During the usage of the payment request module, the system shall request from the member user from whom the payment shall be collected from, to transfer to the member workplace (merchant), a confirmation within a pre-determined period of time. In the case that the confirmation period is exceeded, the system shall determine that the payment request has expired, and the process shall be deemed unsuccessful and the payment process shall be cancelled. If the payment process is cancelled, a warning shall be sent by the system, to the member user from which the payment was requested, and to the member user who has requested the payment and also to the member workplace (merchant) who was supposed to receive the payment.

During the usage of the payment request module, if desired, the member user by whom the payment has been requested to be paid to another member user can, if he/she desires, give an automatic payment confirmation for the amount that has been determined based on the member user for users that have been determined among users that the member user has added via the member addition module and from which the payment request has been made and can transfer payment to the member workplace (merchant) by means of this automatic confirmation process.

### F. Payment Transfer Module:

The payment transfer module basically enables to transfer the payment to the member workplace (merchant) from the member user that shall be using the system, by using at least a “temporary limit credit card” that has been registered by the member user for himself/herself who has been added to the application via the member addition module

The payment transfer module in this embodiment of the invention, is based on the principle that the payment request submitted to the system is submitted to the related credit agency or bank by the system, and this agency transfers the payment to the member workplace (merchant), and the schematic view according to this embodiment has been given in FIG. 4.

The completion of the payment transfer module functions according to the embodiment of the invention is carried out by means of the process steps mentioned below.
In order to transfer payment to a member workplace (merchant) by using at least one temporary limit credit card that has been defined by the member user for the person who has at least a card registered under his name in the system and who has been added to the application via the member addition module, the member user shall search the member workplace (merchant) who shall be receiving the payment, by entering the member workplace (merchant) code that has been assigned by the system for said workplace (merchant), by selecting the member workplace (merchant) to which the payment shall be transferred, from the “payment transfer” screen that can be viewed in the mobile application.
After the member workplace (merchant) to which the payment shall be transferred is found, the payment order is submitted to the system.
The payment order received is submitted by the system to the credit agency or bank.
The credit agency or the bank that has received the payment order for the member workplace (merchant), transfers the payment to the member workplace (merchant).
The member user and member workplace (merchant) is notified after the payment to the member workplace (merchant) is transferred successfully from the credit card of the user.
The member workplace (merchant) and the other member user who has sent the temporary limit to the member user notifies via the application that the payment to the member workplace (merchant) has been transferred from the temporary limit credit card.
If the payment to the member workplace (merchant) is unsuccessful a warning message is submitted to the member user and the member workplace (merchant) via the application.

According to another embodiment of the invention, the payment transfer module, enables the transfer of the payment by the system to the member workplace (merchant) by processing the payment order submitted to the system. The schematic view relating to this embodiment is shown in FIG. 5.

In this case, the member user who has requested payment to be transferred to the member workplace (merchant) transfers the related payment to the system instead of transferring the payment directly to the member workplace (merchant), and the system transfers the related payment to the member workplace (merchant).

The completion of the payment transfer module functions according to the abovementioned embodiment of the invention is carried out by means of the process steps mentioned below.
In order to transfer payment to a member workplace (merchant) by using at least one temporary limit credit card that has been defined by the member user for the person who has at least a card registered under his name in the system and who has been added to the application via the member addition module, the member user shall search the member workplace (merchant) who shall be receiving the payment by entering the member workplace (merchant) code that has been assigned by the system for said workplace (merchant), by selecting the member workplace (merchant) to which the payment shall be transferred, from the “payment transfer” screen that can be viewed in the mobile application.
After the member workplace (merchant) to which the payment shall be transferred is found, the payment order is submitted to the system.
The payment amount collected from the credit card that belongs to the member user is transferred to the member workplace (merchant) by the system,
The member workplace (merchant) and the other member user who has sent the temporary limit to the member user notifies via the application that the payment to the member workplace (merchant) has been transferred from the temporary limit credit card.
If the payment to the member workplace (merchant) is unsuccessful a warning message is submitted to the member user and the member workplace (merchant) via the application.

It is possible for the system to collect a predetermined service fee, in order to carry out unlimited processes during a certain period of time via the package payment method or payment per process method, from all member user types, during usage of each module that has been defined above as the modules of the system.

The payment to be transferred to the member workplace (merchant) can be transferred to the bank account of the member workplace (merchant) or any other bank account that is provided by and belongs to the member workplace (merchant).

### DETAILED DESCRIPTION OF THE ANOTHER EMBODIMENT

In development of the account sharing system of the invention which is another embodiment, it is aimed;
To avoid the transfer of money, sharing of a physical card or card information.
To maintain the authorizations of the sharing person on the shared money and account.
To ensure that the transactions regarding the shared account are traceable by the account owner.
To provide a flexible structure in which users can define the relationship between the account and the card and to use the same account at any time by connecting a different means of payment.
To add additional functions such as amount, duration, usage place restrictions and expenditure management features as usage parameters on the shared account.

In this another embodiment of the invention, the limit is shared between the pre-paid cards issued by the company. By the limit feature defined in said cards, a payment function is provided such that the shopping performed by the sub-users can be paid from the account of the user who has defined the limit (main account).

Here, there are two different limit sharing methods as blocked and non-blocked and, in both methods, the main account defines and authorizes the sub-users.

The main account owner defines a right of use for the sub-users within his own balance, however in the process, money transfer between main and sub accounts is not available, and the balance is recorded on the main account.

At this point, the main account owner grants the sub-users an authorization only for transaction, the user who is the main account owner is responsible for all the transactions performed over the account and the system assumes that all the transactions are made by the main account. However, the tracking records of the transactions performed by the sub-users are monitored and saved.

Limit sharing is performed by a definition between the-member cardholders. The user who is the main account owner selects the person or the people to whom he desires to define a limit from the list of people, and he can define a limit with a desired amount from his own account.

This definition process is only executed as granting a right of use to another user from the balance and does not contain any transfer of balance. In other words, the defined limit is only defined for other users as a right of usage and the electronic money (balance) stays in the balance account of the person who defines the limit.

The defined limit can be assigned to more than one sub-user at the same time. All control of the assigned limit is under the control of the user who assigns the limit. Said user has a privilege to manage and perform revisions including cancellation on the assigned amount.

The limit assignment between the users can be performed by phone number, account number, identification number, card number or another unique identifier. If desired, the authorization procedures of the limit assignment functions can be set-up as verification over SMS, mobile application or the web.

When the limit is assigned, the shared limit is assigned to a plurality of people, a single limit pool is used. When said pool is used, the balance is updated online and the usage rights of all users are deducted from the limit pool by the usage amount.

In all transactions, during authorization, the balance of the main account is checked for sufficient funds. If the defined limit and the balance of the main user are sufficient, the authorization is granted.

Limit sharing is set-up in two ways as blocked and non-blocked;
In the blocked sharing, the shared amount is blocked on the main user's account. This means that the main user can't use the shared amount and said user's available balance is calculated as subtraction of blocked amount from main balance.
In the non-blocked sharing, the shared amount is not blocked on the main user's account and the main user has the right to use all of his/her balance. If the main user spends his/her own balance, the incoming transactions of the people that have the right to use the limit are authorized over the main account's balance according to limits defined by the owner of the main account. If there is sufficient balance in the main account, the transaction is authorized.

Exemplary transaction scenario: In the embodiment of the invention described here; let's assume that the person who defines the limit is account A, and there is 8000 TL in account A.—

In the provided example, before defining the limit, the balance of A1 was defined as 400 TL and the balance of A2 was defined as 500 TL.

In the example, the user A defines a limit of 1000 TL for the users A1 and A2.

The user A can perform the sharing in two ways such as blocked and non-blocked.

The example application of the balance, limit and authorization procedures of the blocked sharing is described below.

In the blocked sharing, the shared balance is restricted for the use of user A by being blocked in the balance of user A. However, here the balance is still kept on account A.

In the case of this example, when the user A shares a 1000 TL blocked limit with users A1 and A2, 1000 TL is deducted from the available limit of the user A and the available balance of the user A becomes 7000 TL.

The balances of the users A1 and A2 will be their current balances+amount remaining from the share. In the example, when the first assignment is carried out but not spent, 400+1000 is defined for A1 and 500+1000 is defined for A2. At this stage, the assignment is only systemic definition and money transfer is not required. Users A1 and A2 can only spend a total of 1000 TL from the shared balance until the balance is completely processed in the account of user A. In this process, no electronic money is issued in the system.

After the limit defining process, if we assume that the user A1 will perform an 800 TL transaction, this transaction is performed over the shared balance since it is over the current balance of the user. Here, the order of the use of the balances will be managed by a parameter.

The 800 TL transaction is executed over the shared limit, which is the balance of account A. Even though the transaction is performed by user A1, that balance is used from the account A. In this flow, besides usage priority of the balances, partial usage is also available as an option. In the partial use, it is possible that first the balance prioritized by the parameter defined by the user A1 (his own main balance or the balance shared by the user A) is used and then the remaining amount is withdrawn from the other balance.

After the 800 TL transaction is authorized by the system, the total balance of A will be reduced to 7200 TL and the shared limit will be reduced to 200 TL.

After this transaction, the users A1 and A2 can only use 200 TL of shared limit. If user A tries a 7200 TL transaction after user A1 uses 800 TL, this transaction will return an insufficient fund result. The reason for this is that the shared limit is shared as blocked. 200 TL of the 7200 TL is kept as blocked for use of A1 and A2.

The user A can have the right to use all his balance by canceling the shared limit definition if desired. At this stage, all usage rights are managed according to the settings of the owner of the account. When desired, user A can cancel the assignments and reset the shared amount.

The 800 TL transaction can be seen in the transaction history of the user A. The responsibility of this transaction belongs to the user A. The transaction is seen in the transaction history of user A, but this transaction is also shown in the transaction history of the A1 user since it is carried out in relation to the shared limit.

When the case where user A shares 1000 TL as non-blocked is examined; the example application of the balance, limit and authorization processes is described below;

After the definition of the limit, the usable balance of the user A will be 8000 TL which is equal to the card balance. The usable balances of the users A1 and A2 will be defined in their current accounts as 400 TL+1000 TL and 500 TL and 1000 TL, respectively.

After user A1 performs 800 TL transaction, the usable main account balance of user A will be 7200 TL. After this transaction, when the user A performs 7200 TL transaction, this transaction will be authorized since there is no blockage on the shared 200 TL and the user A can spend his entire balance.

With the model used in another application of another embodiment of the invention, the main object is that instead of transferring money to other users, the account-sharing person can easily share a determined amount among the people and maintain their control over money and manage these usage parameters in relation to the money shared to these people. Thus, an alternative model is presented to the users by managing the accounts and the access rights to these accounts instead of the uncontrollable money traffic that is experienced continuously.

At the same time, opening a bank account or having a credit card requires certain conditions and requirements. Therefore, there is frequent card information sharing or physical card sharing among people. Sharing the cards between people in this way causes theft of card information, unauthorized transactions or illegal results. Users who do not want to share their card or card information have to give up shopping or take the time to do it themselves.

Often companies experience the following in the spending process: If a certain amount of subsistence is given by money transfer, the unspent amount of the subsistence must be transferred back. This means additional work and process, and in some cases, if no transfer is made, an effort is made to collect the unused amount by the authorities.

At the same time, after sending money, expenditures are tracked online and spending authorizations cannot be controlled.

In the wallet sharing model, as in the example above, the amount of subsistence is not given by money transfer, but as the account sharing/usage right for a certain period of time, the need to transfer the unused amount back is completely eliminated.

No matter when the wallet sharing is made by the person, it can be made transitorily by determining the start-end dates. This feature also offers the person to share a pre-planned pre-definition.

In FIG. 2, spending flow is shown as an open circuit board operation. In this example representation, standard flows are performed on the card, terminal, acquirer and payment network. These flows can vary depending on the type of transaction. Although the payment instrument and system are of different variants, the transaction coming to the system is subject to controls, and authority appropriate to that payment instrument, and the shared account usage described in the main useful model is managed by the central system regardless of the payment instrument.

### DETAILED DESCRIPTION OF THE MODEL

In its basic form, the account sharing model of the invention comprises at least one server and at least one mobile application or web site.

In order for the system to be activated, the mobile application needs to be installed onto a mobile or similar device which may belong to any user and user record needs to be created in the server. As the account sharing payment tool will be integrated into the existing card payment systems structure, as basic card payment components, at least one member workplace (merchant), the financial institution to which the member workplace (merchant) is affiliated and the intermediary institution that provides the accounting and communication between institutions and their existing systems are required in order for people to spend money,

The operation and use of the model is carried out through the modules described below;

### A. Application and User Management Module:

In order to open an account in the system, the user must give the necessary information to the system during the registration step. After the control and approval of the information received from the user, the necessary user records are created in the system. The password setting steps that are also used in introduction to the application, customer verification and determining the limits according to the verification method is also provided at the application step. The relevant module, which provides the systemic management of all these processes, creates their records and manages the life cycle, is the application module.

The following steps describe the application process;
The process begins with the installation of the mobile application by the user on a mobile or similar device. The application is downloaded to the device from the relevant application pool in accordance with the mobile operating system used. The operating system used by the device, the application suitable for the device and version are presented in the pool.
Following the opening of the installed application by the user, the information requested in the application processes is received by directing the customer through the application.
The necessary information is checked with the application module of the information given by the user, and the user is verified with the necessary verification code (SMS/e-mail) etc. steps to verify the customer.
If there is no obstacle in the verification and registration of the user, user records are created in the system and the authorization to enter the mobile application is defined.

### C. Account and Card Management Module:

Users registered in the system can create an account and payment tool through the application. The payment tool can be of many different types. These can be different types of open or closed loop payment tools such as physical magnetic card, chip card, chip and near field communication (NFC) contactless card, Quick Response Code (QR Code), mobile payment card, Host Card Emulation (HCE), embedded Secure Element (eSE), Apple Pay™, Google Pay™ etc.), virtual card, mobile application (in-app payment), web portal (in-app payment). The term payment instrument used in this document covers all payment instruments. The use of a payment instrument in the proposed model is necessary for the use of money. However, the payment instrument used does not essentially affect the use of the model and can operate independently from the payment instrument. The user can use the payment instrument he/she desires by adding or changing it through the application.

### Creating an Account

As soon as the users are registered to the system, a default account is assigned. If a different account is not defined in the system, the user can carry out financial transactions from this account with a default exchange rate. At the same time, account sharing functions offered through a single account can be executed.

The user can create different accounts in the system. To do this, he/she has to perform the following steps;
The user logs into the application and starts the account creation step from the relevant menu.
After entering and confirming the basic data such as the account name to be created and exchange rate information, the account is actively displayed on the application.

### Creating a Payment Instrument

Users registered in the system can create a payment instrument through the application or can request a physical payment instrument.
To create the payment instrument, the type of payment instrument desired to be created on the relevant menu is selected and the creation is performed by filling in the required information. When a physical payment instrument is created, the requested payment instrument is transmitted to the specified address and is delivered to the user.

### Identifying a Prepaid Card

In order to obtain physical cards, users can register the cards with or without the amount they receive from various stores into the application as a payment instrument by entering their card information through the application. They enter the card information that they want to register to the system via the application and after the verification steps, the information is registered in the system as a payment instrument.
   Users registered in the system can create an account and payment tool through the application.
The user logs in to the application and opens the account he/she wants to associate with the payment instrument from the relevant menu.
When the “add-payment-instrument” button is pressed, the payment instruments created by the user are displayed.
The user selects and approves the payment instrument he/she wishes to associate.
The relevant account and payment instrument are associated with each other in the system and after this transaction, transactions from the associated payment instrument are carried out from the account to which it is linked.

The users match their payment tools with their accounts in order to use their existing accounts for their expenditures. If the user has a single account, all payment instruments created are linked to this account.

Creating a payment instrument is optional and it is possible for the user to use the system without defining a payment instrument.

Users who do not create a payment instrument but have at least one active account in the system can share via this account and can use this account for transactions (e.g. paying bills, paying to contracted e-commerce sites) for making direct payments within the application.

### D. Account Sharing

Users get a default account when they are included in the system. Even if they have a single account or different accounts, they can open their accounts to people.

To share the account, the following steps are performed;
The user logs into the application and selects the account he wants to share.
Clicks on the “share account” button on the selected account screen.
He/she chooses the person he wants to share with by determining the recipient on the page that is opens.
On the page opened with the choice of person, the user selects on category basis or member workplace (merchant) basis, the sharing name, the amount of sharing, the duration of sharing (can be selected indefinitely), or the date range (start and end date) within which the sharing will be valid.
If the user wants to assign more than one person for the same sharing, the user performs the step of adding another person.
The user selects whether the shared amount is blocked or unblocked on the account.
The user views summary information with the confirmation stage and approves sharing.
After this process, the account sharing request is submitted to the approval of the people shared.
After the approval of the people shared through their applications, the sharing starts.
When the sharing starts, the person who shares can view the amount of sharing and how much money he/she has left for use from that account according to the status of the account being blocked or unblocked.
With the start of the sharing process, the people who are shared will be able to see the accounts shared over the application.
Shared people can spend by the shared account by associating their existing payment means with the account or by using the shared account directly at the in-app payment points.

### Blocked and Non-Blocked Sharing

Account sharing can be made as blocked or non-blocked. The amount shared in the blocked share is blocked from the money on the account and closed for the use of the shareholder and the balance that can be used is shown by deducting the blocked amount from the account balance. In this case, the sharing user will not be able to use the amount they share in their own expenditures.
In non-blocked sharing, the sharing person has the right to spend all the money in the account and all the amounts in the account appear as available balance.

### Creating Usage Restrictions

Spending restrictions can be imposed while sharing. Spending restrictions can be created in 2 ways. The first of these may be determining the spending limits according to category. The person can choose the channels to which the shared people can spend or limit it to a certain amount. This restriction can be made by grouping the member workplace (merchant) category codes or with a single category code. In more detail, users can also group category codes themselves and define restrictions on usage.

A different restriction can be made specifically for the member workplace (merchant). By listing the member workplaces (merchants) that have been previously used, it will be possible to ban the selected member workplace (merchant) completely, to select only that member workplace (merchant) or to set a limit on the basis of the member workplace (merchant).

With transaction types and sub-transaction codes, limitation or blocking can be applied on a transaction basis. In addition to these, it is possible to create restrictions on the basis of e-commerce, cash withdrawal, sending money, Mo/To, domestic and international transactions etc.

### Sharing Request

Sharing requests can be sent through the system. The process is as follows;
After logging into the application, the person with whom sharing can be requested from is determined on the screen.
Then the requested amount, explanation and duration are entered with the submit button after entering the information.
The request is delivered to the requested person through the application.
The person reads the request information, if he/she approves, the account is selected and the sharing parameters are displayed as in sharing again. This time, the sharing parameters are filled in by default, as requested. The user can change these parameters if he/she wishes.

1. A method of account sharing comprising
a management application module, the method comprising:
downloading an application specific to the account sharing system on a mobile device followed by,
a user entering requested information to the application,
controlling of information entered by the user and verifying a customer,
creating user records in the system if there is no obstacle that prevents verification and registration of the user,
granting authorization to log in to the system,
and an account sharing module that manages the steps of:
the user selecting an account the user wants to share,
the user selecting a recipient,
selecting a sharing name, an amount of sharing, a duration of a sharing process or a date range and optional restrictions for use of the share,
selecting whether the shared amount is blocked or unblocked on the account,
confirming the sharing,
starting the sharing process after approval via the application of the recipients.

2. The method according to claim 1, further comprising
an Account and Card Management Module managing the steps of:
creating a payment instrument or requesting a physical payment instrument, and
opening of an account by the user which the user wants to associate with the payment instrument.

3. The method according to claim 1, wherein the account sharing module further comprises blocked or non-blocked account sharing.

4. The method according to claim 3, wherein when the account sharing is blocked, the shared amount is blocked from money of the account and the shared amount is closed to the use of the sharing person.

5. The method according to claim 3, wherein when the account sharing is non-blocked, the shared amount is open for the use of the sharing person.

6. The method according to claim 2, wherein the payment instrument is at least one of a physical magnetic card, a chip card, a chip and contactless card, Near Field Communication (NFC), a code Quick Response Code (QR), a mobile payment card, Host Card Emulation (HCE), embedded Secure Element (eSE), a virtual card, a mobile application, and a web portal.

7. The method according to claim 6, wherein the mobile payment card is at least one of Host Card Emulation (HCE), embedded Secure Element (eSE), Apple Pay™ and Google Pay™.

8. A computer program product for performing account sharing comprising: a non-transitory computer-readable medium comprising code for causing the steps of claim 1 to be performed.

9. The computer program product according to claim 8, further comprising code for causing the steps of claim 2 to be performed.

10. The computer program product according to claim 8, further comprising code for causing the steps of claim 3 to be performed.

11. The computer program product according to claim 8, further comprising code for causing the steps of claim 4 to be performed.

12. The computer program product according to claim 8, further comprising code for causing the steps of claim 5 to be performed.

13. The computer program product according to claim 8, further comprising code for causing the steps of claim 6 to be performed.

14. The computer program product according to claim 8, further comprising code for causing the steps of claim 7 to be performed.

15. An apparatus for performing account sharing comprising: a processor; a memory in electronic communication with the processor; instructions stored in the memory, the instructions being executable by the processor to cause the performance of the steps of claim 1.

16. The apparatus of claim 15, wherein the processor causes the steps of claim 2 to be performed.

17. The apparatus of claim 15, wherein the processor causes the steps of claim 3 to be performed.

18. The apparatus of claim 15, wherein the processor causes the steps of claim 4 to be performed.

19. The apparatus of claim 15, wherein the processor causes the steps of claim 5 to be performed.

20. The apparatus of claim 15, wherein the processor causes the steps of claim 6 to be performed.
